(19) United States
(12) Patent Application Publication
(10) Pub. No.: US 2006/0225590 A1
(43) Pub. Date: Oct. 12, 2006

(54) Print unit with single motor drive permitting autoplating

(75) Inventors: Douglas Joseph Dawley, Dover, NH (US); Brian Joseph Gentle, Rochester, NH (US); Erik John Ramsay, Nottingham, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/401,140

(22) Filed: Apr. 10, 2006

Related U.S. Application Data
(60) Provisional application No. 60/670,187, filed on Apr. 11, 2005.

(51) Int. Cl. B41F 7/02

(52) U.S. Cl. 101/217

(57) ABSTRACT

A web offset print unit includes a first plate cylinder, a first blanket cylinder selectively in contact with the first plate cylinder, a second blanket cylinder, the web passing between the first and second blanket cylinders, the second blanket cylinder and first blanket cylinder being selectively disengageable from the web in a throw-off position to permit the web to pass between the first and second blanket cylinders, and a second plate cylinder selectively engageable with the second blanket cylinder. A single drive motor drives the first plate cylinder, first blanket cylinder, second blanket cylinder and second plate cylinder when the first and second blanket cylinders engage the web and the single drive motor rotates the first and second plate cylinders when the first and second blanket cylinders are in the throw-off position. Autoplating during the throw-off position thus is possible.

This application claims priority to U.S. Provisional Application No. 60/670,187 filed Apr. 11, 2005, and hereby incorporated by reference herein.

### BACKGROUND

The present invention relates generally to printing presses and more specifically to web offset printing presses having removable sleeve-shaped blankets.

U.S. Pat. No. 4,240,346 describes for example a printing press with two blanket cylinders separable from each other to permit a blanket throw off.

In such presses, the blankets are offset from a vertical from each other, and in order to pass the web through the blankets when the blankets are offset, lead rolls or air bars are necessary to properly guide the web through the blankets. These guides can mark the printed product and also alter registration of the web between two printing print units, causes deteriorated print quality.

U.S. Pat. No. 5,678,485, hereby incorporated by reference herein, discloses a counterpoise and lift mechanism to permit a blanket cylinder to be cantilevered to permit a sleeve-shaped blanket to be slid on and off the cylinder body.

Semi-automatic or fully automatic plating (autoplating) mechanisms are known which permit plates to be attached to the plate cylinder. U.S. Pat. No. 5,495,805 for example is hereby incorporated by reference herein. The plate cylinder should be driven to permit such autoplating.

### SUMMARY OF THE INVENTION

When throwing-off the blanket cylinder to permit axial removal of sleeves with a single motor drive unit, the blanket cylinder gears are disengaged so that autoplating of both plate cylinders using the single drive motor for the unit is not possible.

An object of the present invention is to permit a single drive motor to drive a print unit while still permitting a wide throw-off of the blanket and permitting autoplating.

The present invention provides a web offset print unit comprising:

a first plate cylinder;

a first blanket cylinder selectively in contact with the first plate cylinder;

a second blanket cylinder, the web passing between the first and second blanket cylinders, the second blanket cylinder and first blanket cylinder being selectively disengageable from the web in a throw-off position to permit the web to pass between the first and second blanket cylinders;

a second plate cylinder selectively engageable with the second blanket cylinder; and

a single drive motor driving the first plate cylinder, first blanket cylinder, second blanket cylinder and second plate cylinder when the first and second blanket cylinders engage the web; and capable of rotating the first and second plate cylinders when the first and second blanket cylinders are in the throw-off position.

The first and second plate cylinders thus can be autoplated using the drive motor.

Preferably, the first and second plate cylinders each have an associated autoplating unit.

The present invention provides a web offset print unit comprising:

a first plate cylinder;

a first plate gear fixedly connected to the first plate cylinder;

a first blanket cylinder selectively in contact with the first plate cylinder;

a first blanket gear fixedly connected to the first blanket cylinder;

a second blanket cylinder, the web passing between the first and second blanket cylinders, the second blanket cylinder and first blanket cylinder being selectively disengageable from the web in a throw-off position to permit the web to pass between the first and second blanket cylinders;

a second blanket gear fixedly connected to the second blanket cylinder;

a second plate cylinder selectively engageable with the second blanket cylinder;

a second plate gear fixedly connected to the second plate cylinder;

a single motor driving the first plate gear, first blanket gear, second blanket gear and second plate gear, the first blanket gear and second blanket gear being engaged when the first and second blanket cylinders engage the web; and

an at least one further gear connecting the first plate gear and the second plate gear in the throw-off position, the first and second blanket gears being disengaged in the throw-off position, the single motor driving the first plate gear, second plate gear and at least one further gear when the first and second blanket cylinders are in the throw-off position.

The at least one further gear may include two further gears, and may be engaged solely during throw-off or during both throw-off and when the web is engaged by the first and second blanket cylinders.

The present invention also provides a method for autoplating a first and a second plate cylinder of an offset print unit, the offset print unit also having a first and second blanket and a single drive motor, the method comprising the steps of throwing-off the first blanket cylinder from the second blanket cylinder to permit the web to pass between the first and second blanket cylinders without contact so as to define a throw-off mode, removing the first plate cylinder from the first blanket cylinder and the second plate cylinder from the second blanket cylinder during throw-off mode to permit changing a first blanket on the first blanket cylinder and a second blanket on the second blanket cylinder, respectively, contacting the first plate cylinder with the first blanket cylinder during throw-off mode to permit the first plate cylinder to be rotated by the single drive motor, and contacting the second plate cylinder with the second blanket cylinder during throw-off mode to permit the second plate cylinder to be rotated by the single drive motor.

### BRIEF DESCRIPTION OF THE DRAWINGS

FIG. 1 shows a web offset printing press having eight print units according to the present invention;

FIG. 2 shows a schematic view of the print unit according to the present invention when the web is engaged;

FIG. 3 shows the print unit in FIG. 2 when the blankets are in a throw-off position and disengaged from the plate cylinder

FIG. 4 shows the print unit in FIG. 3 when the blankets are thrown off but the plate cylinders are against the blanket cylinders to permit autoplating;

FIG. 5 shows a schematic end view of the print unit in FIG. 2; and

FIG. 6 shows a schematic end view of the print unit in FIG. 3.

### DETAILED DESCRIPTION

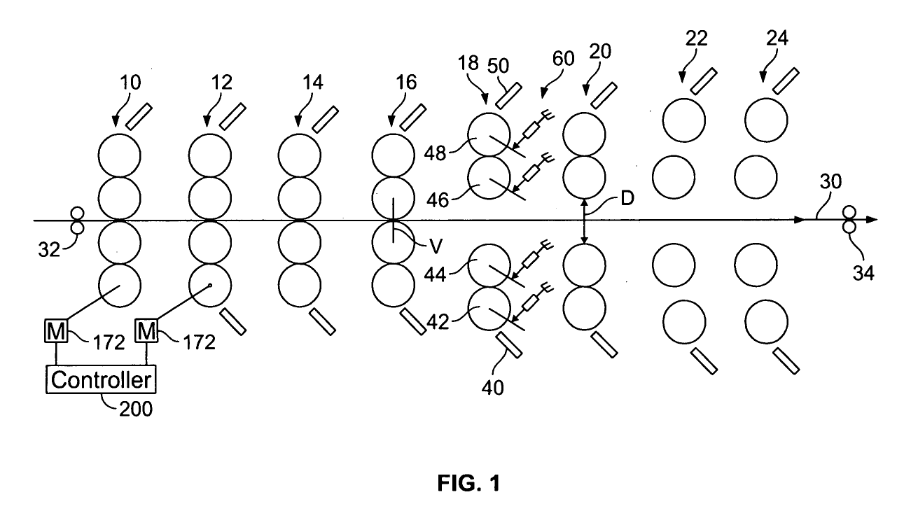

FIG. 1 shows a web offset printing press having eight offset print units 10, 12, 14, 16, 18, 20, 22, 24, each having a plate cylinder 42, blanket cylinder 44, plate cylinder 48 and blanket cylinder 46. Blanket cylinders 44 and 46 nip a web 30 in a printing mode, as shown for print units 10, 12, 14, 16, which may print black, cyan, yellow and magenta, respectively for example. The web may enter the print units via nip rollers 32 (which may be infeed rollers for example) and may exit via exit rollers 34, which may for example be located downstream of a dryer.

The blanket cylinders 44, 46 for each print unit may be thrown-off, as shown for units 22 and 24, so as to separate from each other and from the respective plate cylinder 42, 48. Plate cylinders 42, 48 may move back into contact with the blanket cylinders 44, 46, respectively, during an automatic plate change operation, for example via automatic plate changers 40 and 50, respectively. Automatic plate changers are described in U.S. Pat. Nos. 6,053,105, 6,460,457 and 6,397,751 and are hereby incorporated by reference herein.

A throw-off mechanism 60 is shown schematically for moving the blanket and plate cylinders 42, 44, 46, 48. Preferably, each print unit is driven by a single motor 172. Each print unit 10, 12 . . . 24 may be the same. The individual motors may be controlled by a common control unit 200, which can also control each throw-off mechanism and each autoplating unit for the entire press.

The web path length between the nip rollers 32, 34 advantageously need not change, even when one of the print units has blanket cylinders which are thrown off. Registration may be unaffected by the throw-off. In addition, no web deflectors or stabilizers are needed, such as lead rolls or air rolls to make sure the web does not contact the blankets 44, 46, which could cause marking.

The throw-off distance D preferably is at least 1 cm and most preferably at least 2.5 cm, i.e. that the web has 1.25 cm clearance on either side of the web. Moreover, the centers of the blanket cylinders 44, 46 preferably are in a nearly vertical plane V, which is preferably 10 degrees or less from perfect vertical. This has the advantage that the throw-off provides the maximum clearance for a horizontally traveling web.

The creation of the large throw-off distance D requires changes from normal gearing and is explained with an exemplary embodiment as follows:

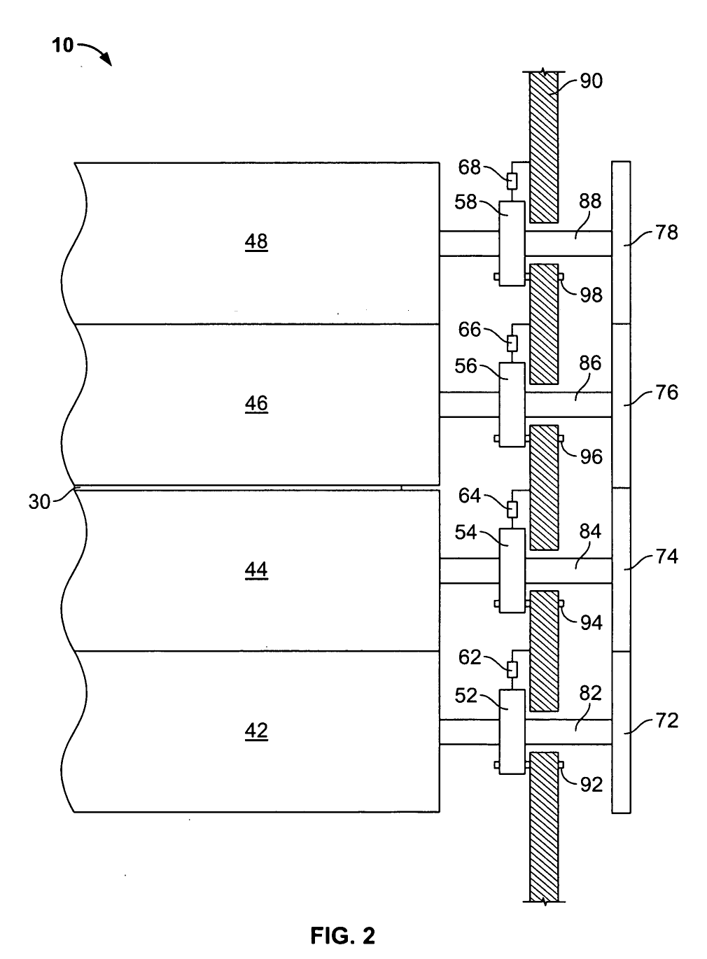

FIG. 2 shows a side view of a print unit 10, for example, in FIG. 1, printing web 30. The web 30 is in contact with blanket cylinders 44, 46, which are in contact with plate cylinders 42, 48, respectively. The cylinders 42, 44, 46, 48 have axle ends 82, 84, 86, 88, which are supported by pivotable support housings 52, 54, 56, 58, which in turn are supported on a frame 90 by pivots 92, 94, 96, 98, respectively. Throw-off actuators 62, 64, 66, 68 of throw-off mechanism 60 (FIG. 1) may pivot the support housings 52, 54, 56, 58 about the pivots 92, 94, 96, 98, respectively. These actuators may be pneumatically operated for example. At the ends of the axle ends 82, 84, 86, 88 are gears 72, 74, 76, 78 respectively, which are geared together during printing.

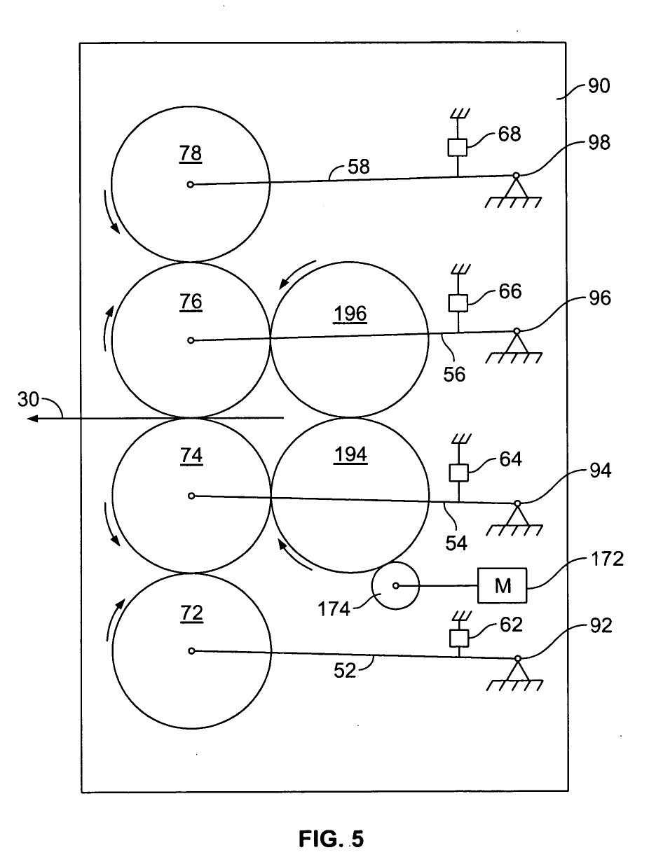

FIG. 5 shows a schematic end view of the gears 72, 74, 76, 78 and their respective support housings 52, 54, 56, 58, pivots 92, 94, 96, 98 and throw-off actuators 62, 64, 66, 68. Two gears 194, 196 supported in frame 90 connect to gears 76 and 74 respectively. A drive gear 174 driven by motor 172 can drive for example gear 194, which in turn drives gears 74 and 196. Gears 174, 194 and 196 may be supported in frame 90 so that their axes do not translate.

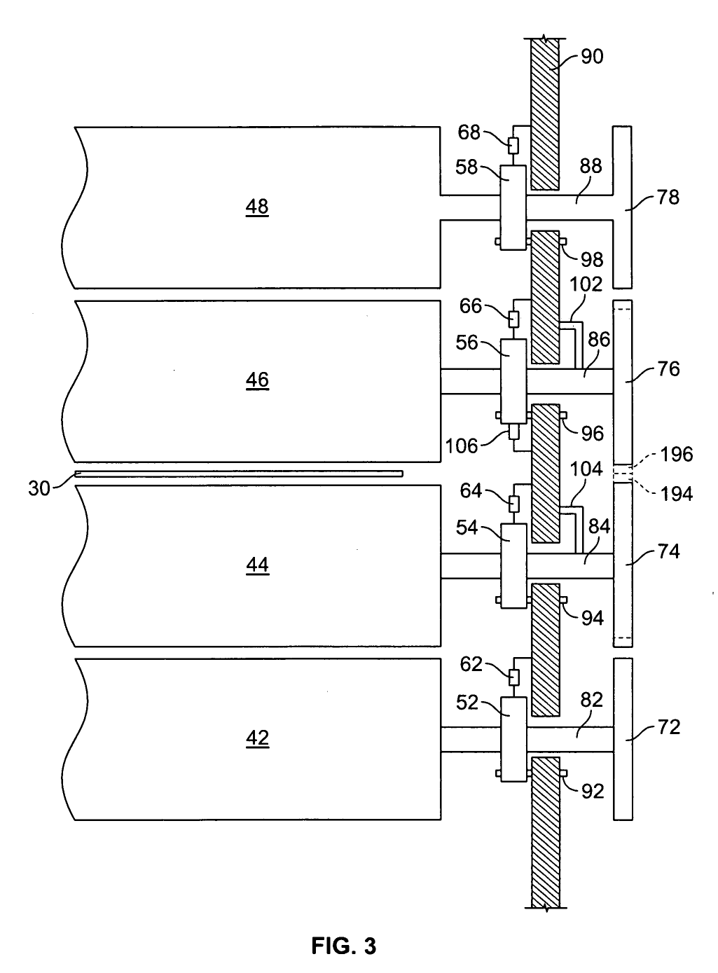

FIG. 3 shows the blanket cylinders 44, 46 thrown off, and the plate cylinders 42, 48 also separated from their respective blanket cylinders 44, 46. The blanket cylinders 44, 46 may be cantilevered using counterpoise devices 102, 104 respectively, and a support device 106 can add additional support to support housing 56, for example. In this position, sleeve shaped blankets on the cantilevered blanket cylinders 44, 46 may be removed via the work-side end as for example described in incorporated-by-reference U.S. Pat. No. 5,678,485.

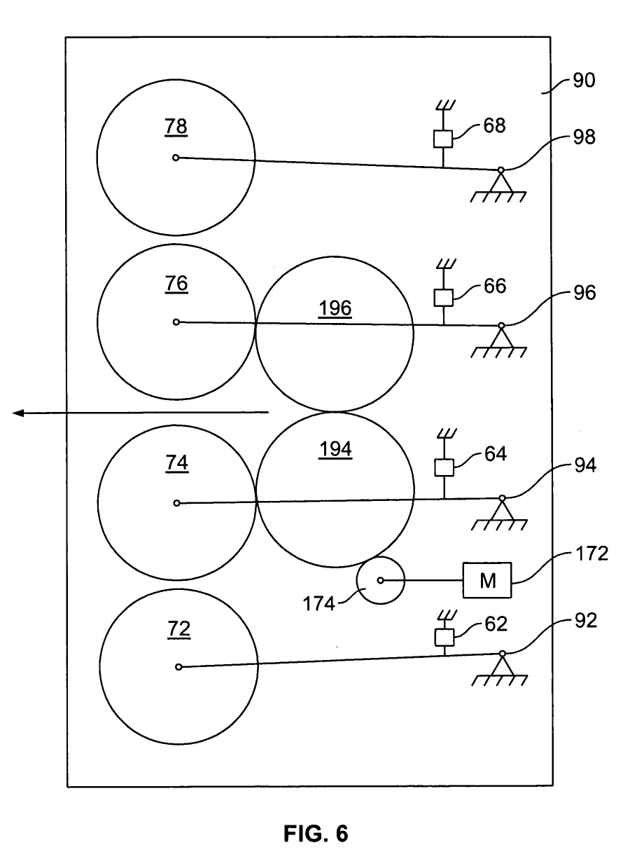

While gears 72, 74, 76 and 78 are disengaged, gears 194 and 196 remain engaged, as shown also in FIG. 6.

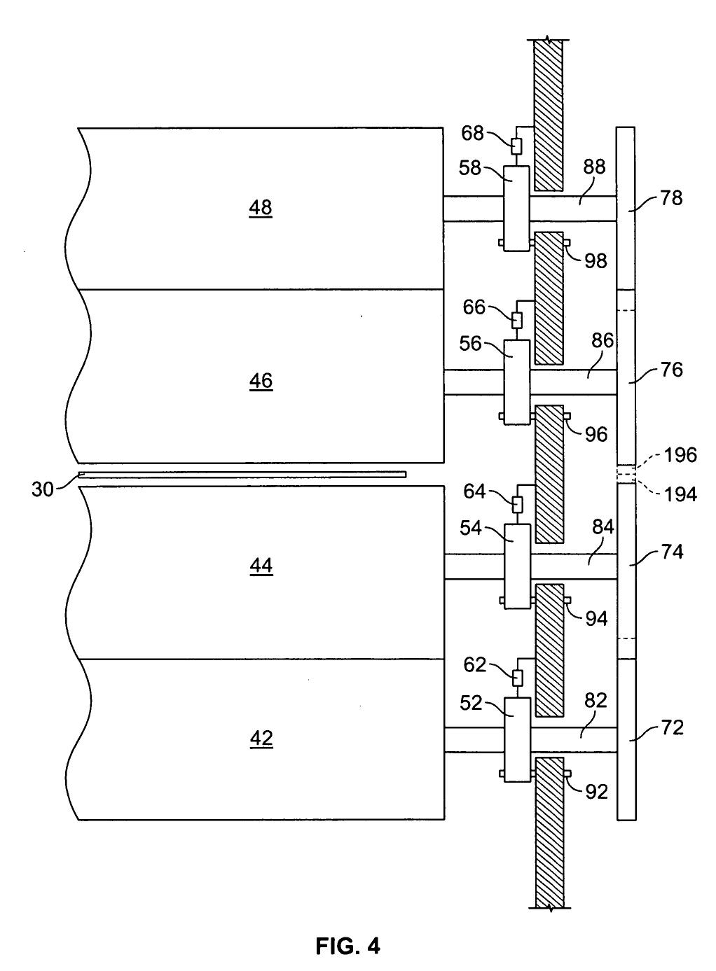

FIG. 4 shows the plate cylinders 42, 48 back in engagement with the respective blanket cylinders 44, 46, but the blanket cylinders 44, 46 remaining thrown-off. Since gears 72 and 74 and 76 and 78 are now engaged, even though gears 74 and 76 are not engaged, the plate cylinders 42 and 48 can be driven for autoplating via gears 194 and 196 by motor 172 and gear 174.

Autoplate units 40 and 50 thus can each function using a single drive motor even while the blanket cylinders 74 and 76 remain thrown-off.

What is claimed is:

1. A web offset print unit comprising:
a first plate cylinder;
a first blanket cylinder selectively in contact with the first plate cylinder;
a second blanket cylinder, the web passing between the first and second blanket cylinders, the second blanket cylinder and first blanket cylinder being selectively disengageable from the web in a throw-off position to permit the web to pass between the first and second blanket cylinders;
a second plate cylinder selectively engageable with the second blanket cylinder; and
a single drive motor driving the first plate cylinder, first blanket cylinder, second blanket cylinder and second plate cylinder when the first and second blanket cylinders engage the web, the single drive motor capable of rotating the first and second plate cylinders when the first and second blanket cylinders are in the throw-off position.

2. The web offset print unit as recited in claim 1 further comprising a first autoplating unit for the first plate cylinder and a second autoplating unit for the second plate cylinder, the first autoplating unit operating when the single drive motor rotates the first plate cylinder and the second autoplating unit operating when the single drive motor rotates the second plate cylinder.

3. The web offset print unit as recited in claim 1 wherein the first blanket cylinder and second blanket cylinder have axially-removable sleeves.

4. The web offset print unit as recited in claim 1 further comprising a control unit controlling the single drive motor and a further drive motor of another print unit.

5. The web offset printing unit as recited in claim 1 wherein the first and second blanket cylinders separate during throw-off by at least 1 cm.

6. The web offset printing unit as recited in claim 1 wherein the web passes between the first and second blanket during throw-off without the aid of any web deflectors or stabilizers.

7. A web offset print unit comprising:
a first plate cylinder;
a first plate gear fixedly connected to the first plate cylinder;
a first blanket cylinder selectively in contact with the first plate cylinder;
a first blanket gear fixedly connected to the first blanket cylinder;
a second blanket cylinder, the web passing between the first and second blanket cylinders, the second blanket cylinder and first blanket cylinder being selectively disengageable from the web in a throw-off position to permit the web to pass between the first and second blanket cylinders;
a second blanket gear fixedly connected to the second blanket cylinder;
a second plate cylinder selectively engageable with the second blanket cylinder;
a second plate gear fixedly connected to the second plate cylinder;
a single motor driving the first plate gear, first blanket gear, second blanket gear and second plate gear, the first blanket gear and second blanket gear being engaged when the first and second blanket cylinders engage the web; and
an at least one further gear connecting the first plate gear and the second plate gear in the throw-off position, the first and second blanket gears being disengaged in the throw-off position, the single motor driving the first plate gear, second plate gear and at least one further gear when the first and second blanket cylinders are in the throw-off position.

8. The web offset printing unit as recited in claim 7 wherein the at least one further gear includes two further gears.

9. The web offset printing unit as recited in claim 7 further comprising a counterpoise device for cantilevering the first blanket cylinder.

10. A method for autoplating a first and a second plate cylinder of an offset print unit, the offset print unit also having a first and second blanket and a single drive motor, the method comprising the steps of:
throwing-off the first blanket cylinder from the second blanket cylinder to permit the web to pass between the first and second blanket cylinders without contact so as to define a throw-off mode,
removing the first plate cylinder from the first blanket cylinder and the second plate cylinder from the second blanket cylinder during throw-off mode to permit changing a first blanket on the first blanket cylinder and a second blanket on the second blanket cylinder, respectively,
contacting the first plate cylinder with the first blanket cylinder during throw-off mode to permit the first plate cylinder to be rotated by the single drive motor, and
contacting the second plate cylinder with the second blanket cylinder during throw-off mode to permit the second plate cylinder to be rotated by the single drive motor.
